(19) United States
(12) Patent Application Publication
(10) Pub. No.: US 2020/0249156 A1
(43) Pub. Date: Aug. 6, 2020

(54) ADVANCED THZ SYSTEM AND METHOD

(71) Applicant: NATIONAL UNIVERSITY OF SINGAPORE, Singapore (SG)

(72) Inventors: Yang WU, Singapore (SG); Hyunsoo YANG, Singapore (SG)

(73) Assignee: NATIONAL UNIVERSITY OF SINGAPORE, Singapore (SG)

(21) Appl. No.: 16/641,927

(22) PCT Filed: Aug. 21, 2018
(86) PCT No.: PCT/SG2018/050424

§ 371 Date: Feb. 25, 2020

(30) Foreign Application Priority Data
Aug. 25, 2017 (SG) 10201706986T

(51) Int. Cl. G01N 21/3581; G01J 3/28; G06N 20/00

(52) U.S. Cl. CPC G01N 21/3581; G06N 20/00; G01J 3/28

(57) ABSTRACT

A THz data acquisition and analysis system, use of the THz data analysis system, and a THz data acquisition and analysis method. THz data acquisition and analysis method comprises performing a THz spectroscopy measurement on a sample; acquiring sample data based on the THz spectroscopy measurement; and performing a comparison between the sample data and reference data for identifying the sample.

### FIELD OF INVENTION

The present invention relates broadly to advanced THz systems and methods, and in particular to THz spectroscopy devices and methods for sample identification, imaging and structure/layer thickness studies.

### BACKGROUND

Any mention and/or discussion of prior art throughout the specification should not be considered, in any way, as an admission that this prior art is well known or forms part of common general knowledge in the field.

Terahertz (THz) technology generally utilizes the frequency band of 0.1 THz to 10 THz, which is between 3 mm to 0.03 mm in wavelengths. After intense research during the past decades in materials, components, and systems, solid foundation in THz technologies has been established. The performance of the THz system keeps increasing while the cost drops substantially. In term of applications, it has been proven that a wide range of materials, such as explosives, tumors, medicines and drugs-of-abuse, have spectrum fingerprints at THz range, which endows the unique capabilities of THz technology in detection of these materials. Additionally, THz waves are able to penetrate through many materials, such as cloth, dry woods, plastics and papers, which enables the THz wave to “see through” these materials and identify the hidden objects.

Embodiments of the present invention seek to provide THz spectroscopy devices and methods for sample identification, imaging and structure/layer thickness studies that seek to exploit the unique capabilities of THz technology.

### SUMMARY

In accordance with a first aspect of the present invention there is provided a THz data acquisition and analysis system comprising:
a THz spectrometer configured for performing a THz spectroscopy measurement on a sample;
a data acquisition unit configured for acquiring sample data based on the THz spectroscopy measurement; and
a processing unit configured for performing a comparison between the sample data and reference data for identifying the sample.

In accordance with a second aspect of the present invention there is provided the use of the system of the first aspect in one or more of a group consisting of safety surveillance; disease diagnosis, including the analysis of biopsy, metabolite, and slide analysis; in skin diagnosis, wherein flexible THz emitters and/or detectors can be bent to fit the human body curvature for accurate analysis; in eye inspection, wherein flexible THz emitters and/or detectors can be bent to fit the cornea curvature for more accurate analysis; in dental care, wherein THz phase array antenna can be applied for a high speed dental check, for instance, for the tooth decay depth before root canal therapy; painting analysis; poisonous gas/air pollution detection; product quality check; beauty treatment & therapy; and restoration of cultural relics.

In accordance with a third aspect of the present invention there is provided a THz data acquisition and analysis method comprising:

performing a THz spectroscopy measurement on a sample;

acquiring sample data based on the THz spectroscopy measurement; and

performing a comparison between the sample data and reference data for identifying the sample.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(A) is a schematic drawing illustrating that a THz system according to an example embodiment can be powered by one or more wall plugs, e.g. 80-220 VAC.

FIG. 1(B) is a schematic drawing illustrating that a THz system according to an example embodiment can be powered by one or more battery base units or DC power supply.

FIG. 2 is a schematic block-diagram illustrating a THz System according to an example embodiment.

FIG. 3 is a schematic block-diagram illustrating a THz System according to an example embodiment.

FIG. 4 is a schematic block-diagram illustrating a THz System according to an example embodiment.

FIG. 5 is a schematic block-diagram illustrating a system and method according to an example embodiment.

FIG. 6 is a schematic block-diagram illustrating a system and method according to an example embodiment.

FIG. 7 is a schematic block-diagram illustrating a system and method according to an example embodiment.

FIG. 8(A) is a schematic drawing illustrating configuration of a THz beam path in one fundamental type according to an example embodiment.

FIG. 8(B) is a schematic drawing illustrating configuration of a THz beam path in one fundamental type according to an example embodiment.

FIG. 8(C) is a schematic drawing illustrating configuration of a THz beam path in one fundamental type according to an example embodiment.

FIG. 8(D) is a schematic drawing illustrating configuration of a THz beam path in one fundamental type according to an example embodiment.

FIG. 9(A) is a schematic drawing illustrating a THZ system according to an example embodiment.

FIG. 9(B) a schematic drawing illustrating arrangement of emitters and detectors in respective arrays according to an example embodiment.

FIG. 10(A) is a schematic drawing illustrating ultra-thin film type THz emitters configured in a near field scheme according to an example embodiment.

FIG. 10(B) is a schematic drawing illustrating sample mapping realized by moving the samples according to an example embodiment.

FIG. 10(C) is a schematic drawing illustrating sample mapping realized by scanning the laser beams according to an example embodiment.

FIG. 11 is a schematic drawing illustrating modulation of the pulsed THz waves by controlling (1) the excitation laser beam, (2) the THz emitter, or (3) the emitted THz beam, resulting to (a) linear polarized pulsed THz beam with controlled polarization direction, (b) circularly or elliptically polarized pulsed THz beam, and/or (c) pulsed THz beam with controlled phase & amplitude.

FIG. 12 is a schematic drawing illustrating a THz pixels (emitters/detectors) array on a flexible substrate according to an example embodiment.

FIG. 13 is a schematic block-diagram illustrating a data analysis method and system according to an example embodiment.

FIGS. 14(A) and (B) are schematic drawings illustrating a THz probe installed under a luggage conveyor belt according to an example embodiment.

FIG. 15 is schematic drawing illustrating THz probes installed under and above a luggage conveyor belt, without/with robotic arms, according to an example embodiment.

FIG. 16(A) is schematic drawing illustrating THz probes installed for shoe scanning according to an example embodiment.

FIG. 16(B) is schematic drawing illustrating THz probes installed in the frame of an entrance gate according to an example embodiment.

FIG. 17 schematic drawings illustrating a THz spectrometer according to an example embodiment.

FIG. 18 shows a schematic diagram illustrating a THz data acquisition and analysis system 1800 according to an example embodiment.

FIG. 19 shows a flow chart 1900 illustrating a THz data acquisition and analysis method according to an example embodiment.

### DETAILED DESCRIPTION

The advanced THz spectrometers according to example embodiments described herein advantageously exhibit a high performance and a very small form factor. Furthermore, the detection productivity, spatial resolution and sensitivity can preferably be greatly enhanced by utilizing THz emitter & detector arrays, and/or near field scanning method, and/or flexible emitters, according to embodiments of the present invention. In order to further improve the accuracy of material identification, real time data acquisition and analysis, a database and machine learning process are proposed in preferred example embodiments. Regarding to THz applications, several methods and implementations utilize the THz spectrometers according to example embodiments in safety surveillance and healthcare. However, embodiments of the present invention can also be applied to other fields, as will be appreciated by a person skilled in the art.

Terahertz (THz) frequencies are a band of the electromagnetic wave spectrum, ranging from approximately or exactly 0.1 THz to 10 THz, corresponding to wavelengths between approximately or exactly 3 mm to 0.03 mm. Compared to its neighbors, e.g. microwaves and infrared waves, which have been intensively studied during the past century and widely applied in our daily lives, the development of THz technologies has relatively lagged. However, it has been demonstrated that a wide range of chemicals, such as drugs-of-abuse and explosives, have intrinsic absorption peaks (analogous to fingerprints) at the THz spectrum range, which endow these waves unique capabilities in safety surveillance related applications. Additionally, some tumors and medicines also have distinctive fingerprints which can also be detected by THz waves, confirming the potential of THz techniques in healthcare, as another non-limiting example.

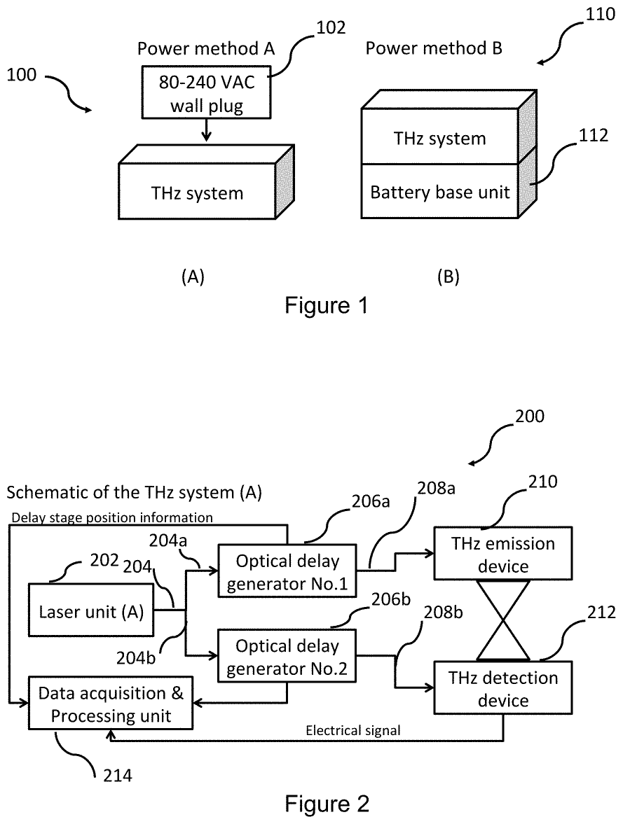

Two example THz systems 100, 110 according to example embodiments are schematically shown in FIGS. 1(A) and (B), respectively. FIG. 1(A) shows that the THz system 100 can be powered by one or more wall plugs 102, e.g. 80-220 VAC, whereas FIG. 1(B) shows that the THz system 110 can be powered by one or more battery base units 112. It is noted that the THz system can be powered by a combination of both one or more wall plugs 102 and one or more battery base units 112 in different embodiments.

THz System 200 according to an example embodiment as shown in FIG. 2 has a laser unit 202 with e.g. femtosecond or picosecond pulses, and the laser beam 204 is split into two beams 204a, b. Two optical delay stages 206a, b are applied for optical delay control, and generally one of the delay generators 206a, b is for a large delay range while the other one is selected for high speed scanning. Eventually, one beam 208a will be sent to the THz emission device 210 and the other beam 208b will be sent to the THz detection device 212. The time delays and the electrical signal from the detection device 212 are correlated and acquired by the data acquisition and processing unit 214. For a more detailed description of an example data acquisition technique for use in the THz System 200 reference is made to “Terahertz-time domain spectrometer with 90 dB peak dynamic range” Journal of Infrared, Millimeter, and Terahertz Waves, Volume 35, Issue 10, pp 823-832 (2014), the contents of which are hereby incorporated by cross-reference.

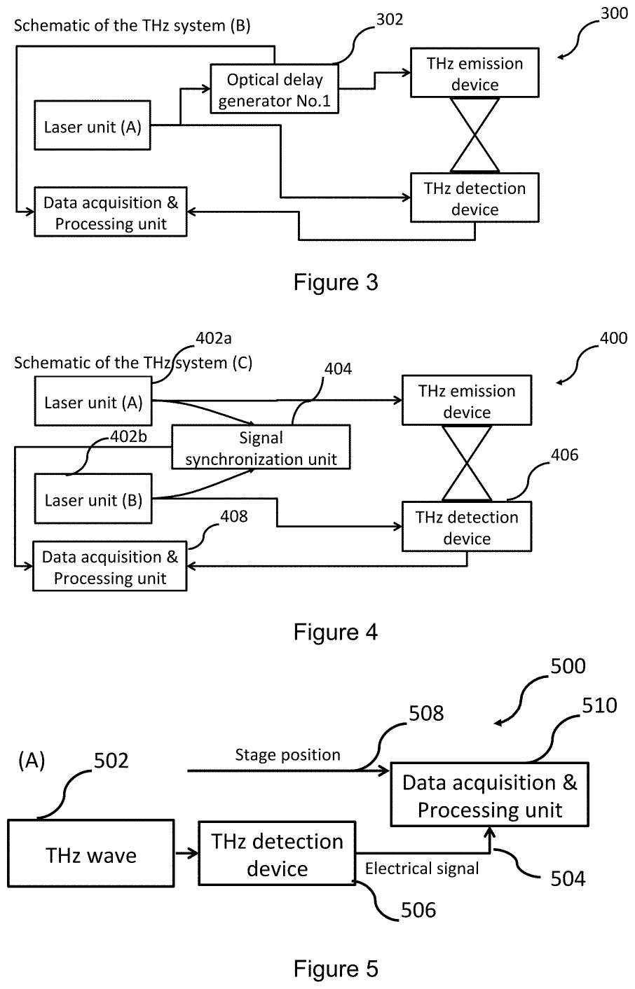

System 300 according to an example embodiment shown in FIG. 3 is similar to system 200, but with only one optical delay line 302. This type of system 300 is specifically constructed for either high speed or large scanning range. For a more detailed description of an example data acquisition technique for use the THz System 300 reference is made to “High-Performance THz Emitters Based on Ferromagnetic/Nonmagnetic Heterostructures” Advanced Materials, Volume 29, Issue 4, pp. 1603031, (2017) the contents of which are hereby incorporated by cross-reference.

System 400 according to an example embodiment shown in FIG. 4 uses two pulsed lasers 402a, b, and the repetition rates of the lasers 402a, b are slightly different. Due to the linear change of the relative time gap between pulses from the two lasers 402a, b, the THz signal sampling can be achieved, which is equivalent to the function of the optical delay stages described above, but with a much faster speed. The synchronization of the two lasers 402a, b can be achieved by actively tuning the repetition rate of the slave laser 402b with respect to that of the master laser 402a; or passively detecting the overlap timing of the laser pulses from two lasers 402a, b and estimating the sampling time step. The information of the synchronization unit 404 and the THz signal from the detection device 406 is transferred to the data acquisition and processing unit 408. For a more detailed description of an example data acquisition technique for use in the THz System 400 reference is made to “High-speed terahertz time-domain spectroscopy based on electronically controlled optical sampling” Optics Letters, Vol. 35, Issue 22, pp. 3715-3717 (2010), the contents of which are hereby incorporated by cross-reference.

In the systems according to the example embodiments described above, the pulsed laser beam can be delivered by fibers or in free space. The resulting pulsed THz emission can be achieved by, for example, one or more of (a) photoconductive antennas, (b) electro optical crystals, including but not limited to ZnTe, DAST, GaP, GaSe, and LiNbO₃ (including their form in waveguides), and (c) magnetic thin films and their heterostructures (the films can e.g. be on a rigid substrates or a flexible substrates). The THz detection can be achieved by, for example, one or more of (a) photoconductive antennas, (b) electro optical crystals, including but not limited to ZnTe, DAST, GaP, GaSe, LiNbO₃, InAs, and InSb, and (c) magnetic thin films and their heterostructures (the films can e.g. be on a rigid substrates or a flexible substrates). In the THz detection devices, the THz signal can e.g. be converted into (a) photo current or voltage, or (b) the polarization variation or intensity variation of the probe laser beam which can be subsequently detected by light-to-electrical signal conversion devices.

The data acquisition in example embodiments can be according to several different methods, examples of which are illustrated schematically in FIGS. 5-7. In FIG. 5, in a method 500 according to an example embodiment, the pulsed THz wave 502 is converted into an electrical signal 504 by the THz detection device 506. Together with the stage position information 508, the data are acquired and processed by the data acquisition unit 510 for the phase sensitive signal processing. For a more detailed description of this example data acquisition technique for use in example embodiments reference is made to “Terahertz-time domain spectrometer with 90 dB peak dynamic range” Journal of Infrared, Millimeter, and Terahertz Waves, Volume 35, Issue 10, pp 823-832 (2014), the contents of which are hereby incorporated by cross-reference.

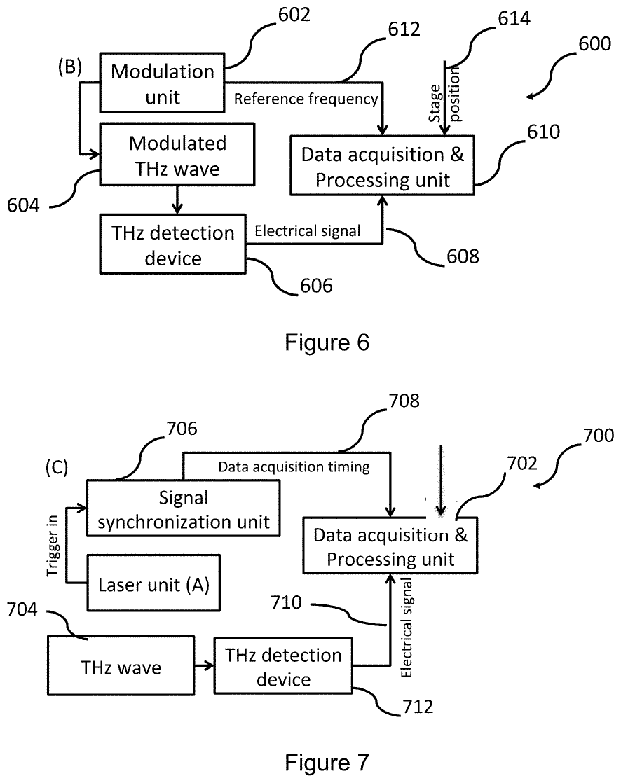

In FIG. 6, in another method 600 for use in an example embodiment, the pulsed THz wave is modulated to a specific frequency by the modulation unit 602 resulting in a modulated THz wave 604, and sensed by the THz detection device 606. The THz wave related electrical signal 608 is sent to the data acquisition device 610 for the phase sensitive signal processing by referring to the reference frequency 612 and the stage position information 614. For a more detailed description of this example data acquisition technique for use in example embodiments reference is made to “High-Performance THz Emitters Based on Ferromagnetic/Nonmagnetic Heterostructures” Advanced Materials, Volume 29, Issue 4, pp. 1603031 (2017), the contents of which are hereby incorporated by cross-reference.

In FIG. 7, in another method 700 for use in an example embodiment, the data acquisition device 702 is synchronized to the pulsed THz wave 704 by a signal synchronization unit 706 providing a data acquisition timing signal 708 and the data in the electrical signal 710 from the detection device 712 are only acquired at the effective time window to enhance the signal to noise ratio. For a more detailed description of this example data acquisition technique for use in example embodiments reference is made to “Enhancement of terahertz wave generation by cascaded χ⁽²⁾ processes in LiNbO₃” J. Opt. Soc. Am. B, vol. 26, pp. A101-A106 (2009), the contents of which are hereby incorporated by cross-reference.

The acquired pulsed THz signal data in the methods for use in example embodiments described above will be correlated with the information of the time delay. With fast Fourier transformation, the THz data in frequency domain are available. The data can preferably be averaged to enhance the signal to noise ratio according to example embodiments.

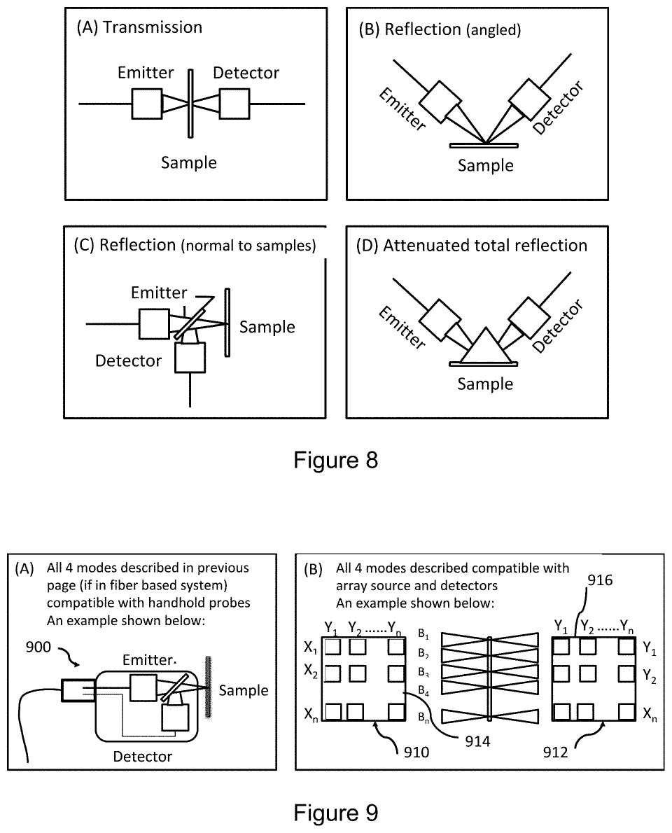

The THz beam path can be configured in different fundamental types or modes in example embodiments. Example modes are illustrated schematically in FIGS. 8(A) to (D), namely in FIG. 8(A) transmission mode, in FIG. 8(B) Reflection mode (angled incidence), in FIG. 8(C) Reflection mode (normal to samples) and in FIG. 8(D) Attenuated total reflection mode. All these example modes are advantageously compatible with free space emitters and detectors, fiber coupled emitters and detectors, or a combination of free space and fiber coupled emitters and detectors.

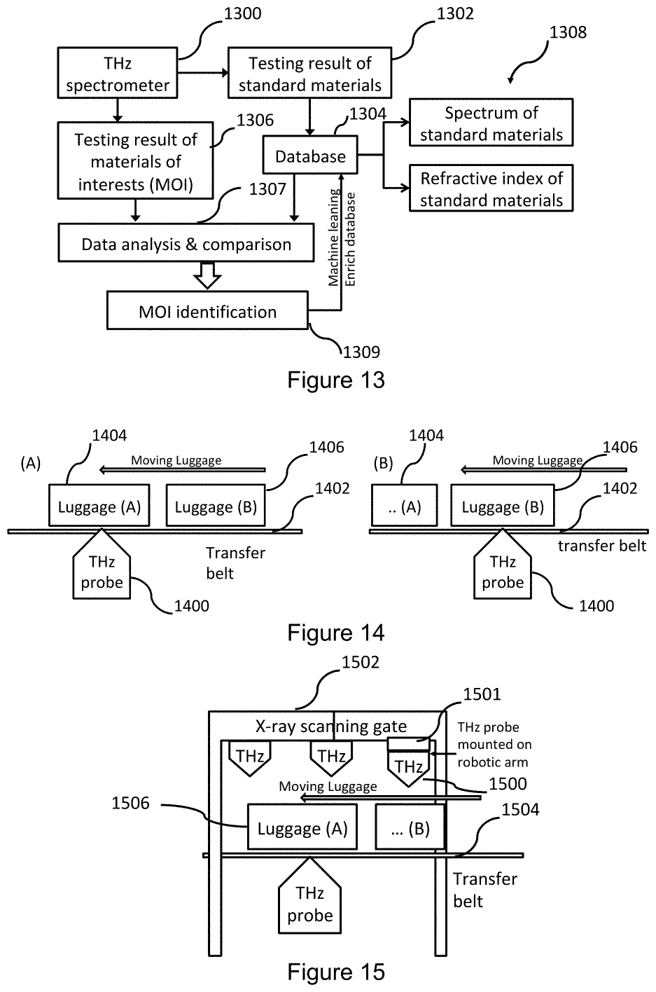

A data analysis method and system 1308 according to an example embodiment of the present invention is shown in FIG. 13: The THz spectrometer 1300 tests standard materials 1302 and accumulates data for a database 1304. When measuring the materials of interests (MOI) 1306, a comparison 1307 will be made between the results from MOI and the existing data in the database 1304. In this way, the system 1308 will be able to identify the MOI 1309. With increased amount of testing data, the THz spectrometer 1300 will preferably be able to enrich the database 1304 by machine learning according to an example embodiment, which will contribute to the identification of new materials and provide more accurate information of the MOI 1309.

The database 1304 is preferably preloaded in the system 1308 for analysis purpose. The database 1304 may contain the THz spectra of a list of materials, including but not limited to explosives, drugs, drug-of-abuses, cells and so on. The database 1304 may contain the refractive index of a list of materials, including but not limited to semiconductors, polymers, carbons, plastics, and so on. The measured data can be updated to the cloud (as a non-limiting example of a shared data centre) to enlarge the database and support all the relevant equipment of the system 1308, according to an example embodiment.

The data are processed in example embodiments by a computing device with an operation system or a standalone devices, such as field-programmable gate array (FPGA) modules, which (a) acquire the THz spectrum of a known specimen to add up the database 1304, (b) identify the specimen by comparing the acquired THz spectrum with the spectra in the database 1307, (c) acquire the material refractive index of a specimen with a known thickness by analysis of the multi-reflection peak positions, (d) calculate the specimen thickness by analysis the multi-reflection peak positions and the material refractive index, and (e) calculate the conductivity of the specimen.

For the modes described above and schematically shown in FIGS. 8(A) to (D), the fiber coupled emitters and detectors can advantageously be fitted into handheld probes according to example embodiments. An example configuration 900 is schematically shown in FIG. 9(A). Furthermore, the emitters and detectors can be arranged in respective arrays 910, 912 (schematically shown in FIG. 9(B)) on a rigid or flexible substrate 914, 916. For THz emitter and detector arrays 910, 912, multiple points check can advantageously contribute to improve the measurement speed and accuracy.

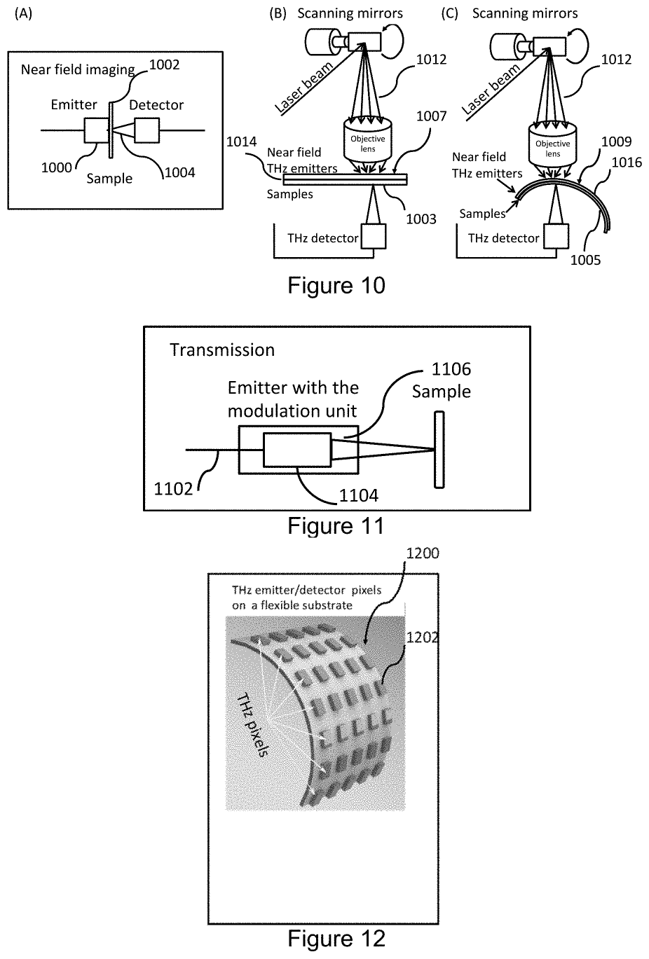

With non-structured, ultra-thin film type THz emitters according to example embodiments, the emitter can be configured in a near field scheme. As schematically shown in FIG. 10(A), one (or more) emitters 1000 is directly attached to the sample 1002 and the locally excited THz waves 1004 will advantageously lead to high resolution THz imaging using a single detector. Multiple detectors may be used in different embodiments. The sample mapping can be realized by moving the sample 1002 and/or scanning the laser beams 1012 (schematically shown in FIGS. 10(B) & 10(C)). In order to improve fit for different samples, the THz emitter(s) 1007 can be prepared on a rigid substrate 1014 (see FIG. 10(B)) or the THz emitter(s) 1009 can be prepared on a flexible substrate 1016 for a curved sample 1005 (see FIG. 10(C)).

In the systems according to example embodiments described above, the pulsed THz waves can be modulated as shown in FIG. 11 by controlling (1) the excitation laser beam 1102, (2) the THz emitter 1104, or (3) the emitted THz beam 1106, resulting to (a) linear polarized pulsed THz beam with controlled polarization direction, (b) circularly or elliptically polarized pulsed THz beam, and/or (c) pulsed THz beam with controlled phase and amplitude. The modulated THz beam 1106 can be configured different configuration modes (i) transmission (ii) angled/normal to sample Reflection (iii) Attenuated reflection (see FIG. 8 and corresponding description above) and (iv) THz beam array (see FIG. 9(B) and corresponding description above.

An example of a THz pixels (emitters/detectors) array 1200 on a flexible substrate 1201 according to an example embodiment is shown in FIG. 12. If required, the THz pixels array 1200 can be bent accordingly. When the phase and amplitude of each pixel are well controlled, the device can preferably form into a phase array antenna according to example embodiments. That is, for THz emitter and detector arrays 1200, by implementing the phase control for each “THz pixel” e.g. 1202, the system can function as phase array antennas for fast imaging and advanced spectrum checking according to example embodiments. THz beam with/without modulation may be arranged on such a flexible substrate 1201 which can be bent into any shape.

Application Scenario Examples According to Example Embodiments

One important application of the advanced THz system according to example embodiments is the safety surveillance in airports and public transportation stations.

For any item or material, whether it is suspicious as explosives, drugs and so on, the specimen can be tested using a THz system according to example embodiments. For general safety inspection, the passengers might be stopped for a security check. Safety guards can lead the passenger to the safety check point which incorporates THz systems according to example embodiments for remote hazards materials check. It is also possible to use the handheld probe (compare FIGS. 9(A) and (B)) to approach and/or sweep the clothes or body of the passengers according to example embodiments.

As another example, in FIGS. 14(A) and (B), a THz probe 1400 is installed under a conveyor belt 1402. Every luggage e.g. 1404, 1406 passed through the THz probe 1400 will be tested. An array of such THz probes 1400 can be installed for multi-point screening. The data acquired by the THz probe or probes according to example embodiments will enable e.g. hazardous material identification.

One or more THz probes e.g. 1500 without/with robotic arms 1501 according to example embodiments can be integrated into existing X-ray scanners 1502, as shown in FIG. 15, below a conveyor belt 1504 or above the luggage e.g. 1506. THz examination will be in place at the same time as X-ray screening. Similar THz integration can be applied with microwave scanners as well in different embodiments.

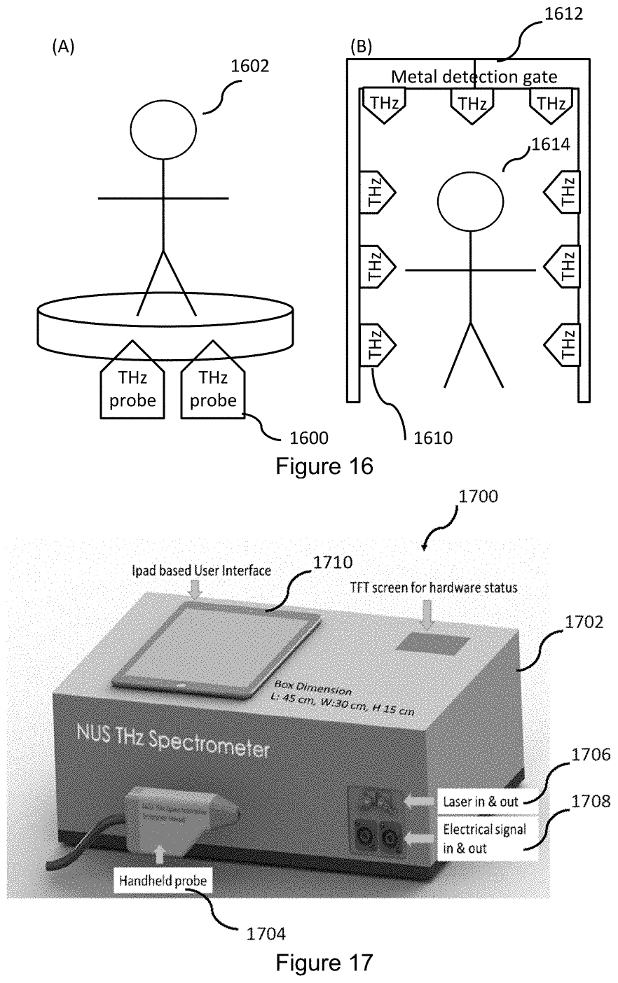

There is a high risk that the hazardous materials, such as drug-of-abuse and explosives, can be hidden inside shoes. The THz probes e.g. 1600 according to example embodiments can be installed to scan the shoes a person 1602 is wearing, as schematically shown in FIG. 16(A).

The THz probes e.g. 1610 can be installed in the frame of the entrance gate 1612 according to an example embodiment, as schematically shown in FIG. 16(B). When the passengers e.g. 1614 walk through the metal detection gate 1612, they will be examined in real time by large distance (e.g. up to 1 meter) rapid scanning, or collect the air mixed with spread powders from the passenger into a gas cell and perform the short distance (0.01-0.05 meter) trace detection. If any spectrum matches with the “dangerous spectrum” in the database, an alarm will be triggered. Due to the fast speed of the THz system according to example embodiments, the passengers advantageously do not need to stop or slow down.

In the embodiments described above with reference to FIGS. 14 to 16, the various THz probes may, for example, be provided in the form of the probe 900 described above with reference to FIG. 9(A).

Nowadays, e.g. water bottles need to be disposed off in the airport and it is not well controlled in the train stations and bus stations. Using the THz technology according to example embodiments, one is preferably able to identify the hazardous liquid without opening the plastic & rubber bottles.

Besides the safety surveillance example applications non-limiting examples of which have been described above, the advanced THz system according to example embodiments can also be applied for disease diagnosis, including the analysis of biopsy, metabolite, and slide analysis. In skin diagnosis, flexible THz emitters and/or detectors can be bent to fit the human body curvature for accurate analysis. In eye inspection, flexible THz emitters and/or detectors can be bent to fit the cornea curvature for more accurate analysis. In dental care, THz phase array antenna can be applied for a high speed dental check, for instance, for the tooth decay depth before root canal therapy.

Furthermore, the THz systems and methods according to example embodiments can be applied to, for example:
Painting analysis
Poisonous gas/air pollution detection
Product quality check
Beauty treatment & therapy
Restoration of cultural relics

An example THz spectrometer 1700 according to an example embodiment is shown in FIG. 17. The main equipment body 1702 in this embodiment includes one set of the components described above with reference to e.g. FIGS. 2-4 for analysis of samples received in a sample chamber (not shown) incorporated in the main equipment body 1702. Handheld probe(s) 1704 can be linked to the fiber and electrical ports 1706, 1708 for portable screening. Smart devices, such as tablets e.g. 1710, laptops, industrial screens are applicable for user interface implementation according to example embodiments. It is noted that in this embodiment the main equipment body 1702 includes emitters/detectors, so that the main equipment body 1702 can be used as a stand-alone device without a portable probe. In different embodiments, the main equipment body may not include emitters/detectors, so that the main equipment body in such embodiment may be specifically for use with a portable probe.

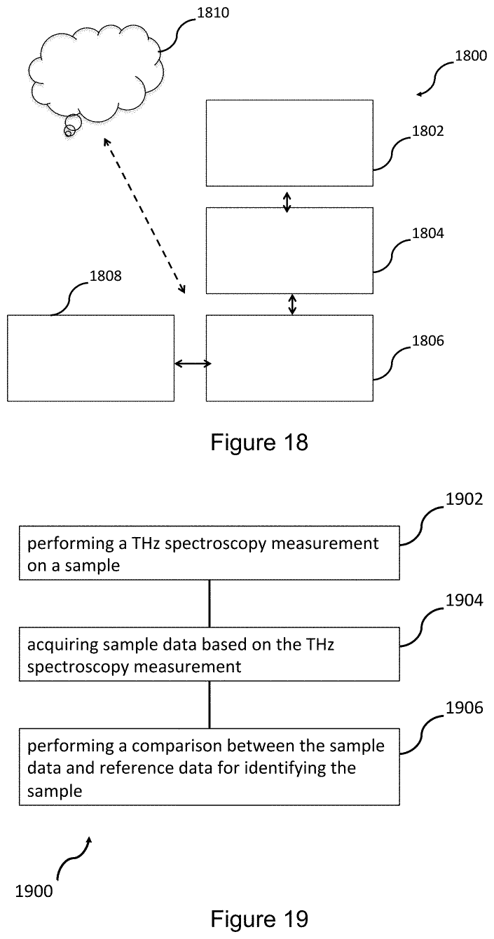

FIG. 18 shows a schematic diagram illustrating a THz data acquisition and analysis system 1800 according to an example embodiment, comprising a THz spectrometer 1802 configured for performing a THz spectroscopy measurement on a sample; a data acquisition unit 1804 configured for acquiring sample data based on the THz spectroscopy measurement; and a processing unit 1806 configured for performing a comparison between the sample data and reference data for identifying the sample.

The processing unit 1806 may be configured for enriching the reference data by performing machine learning using the sample data upon identification.

The system may comprise a database 1808 for the reference data. The database 1808 may also contain a refractive index of a list of materials.

The reference data may be stored in a shared data centre external to the system 1800, such as in a cloud data base 1810.

The processing unit 1806 may comprise a computing device with an operation system and/or a standalone device, such as field-programmable gate array (FPGA) modules.

The processing unit 1806 may be further configured to determine the refractive index of the sample. The processing unit 1806 may be configured to analyse multi-reflection peak positions for the sample with known thickness, and to calculate the refractive index of the sample, which may include performing machine learning.

The processing unit 1806 may be configured to measure the thickness of the sample. The processing unit 1806 may be configured to analyse multi-reflection peak positions of the sample with known refractive index, and to extract the thickness of the sample. The processing unit 1806 may be configured to calculate the optical conductivity of the sample based on measurement of the transmission or reflection of the sample.

The THz spectrometer 1802 may comprise an array of emitters and/or an array of detectors. A number of emitters and a number of detectors may be the same or different. The array of emitters may be mounted on a substrate. The array of detectors may be mounted on another substrate or on the same substrate. The substrate or substrates may be flexible. At least one of the substrates may be configured for supporting and/or conforming to the sample.

The system 1800 may be configured as a portable unit.

The THz spectrometer 1802 may be configured to receive a laser beam for excitation of the THz signal via a free space interface and/or a waveguide interface, such as an optical fibre interface.

The system 1800 may be incorporated into an existing surveillance or healthcare apparatus, such as an X-ray scanning apparatus or a metal detector.

The system 1800 may comprise a robotic arm for positioning at least the THz spectrometer 1802 relative to the sample.

In one embodiment, the use of the system 1800 described above with reference to FIG. 18 of any one of the preceding claims in one or more of a group consisting of safety surveillance; disease diagnosis, including the analysis of biopsy, metabolite, and slide analysis; in skin diagnosis, wherein flexible THz emitters and/or detectors can be bent to fit the human body curvature for accurate analysis; in eye inspection, wherein flexible THz emitters and/or detectors can be bent to fit the cornea curvature for more accurate analysis; in dental care, wherein THz phase array antenna can be applied for a high speed dental check, for instance, for the tooth decay depth before root canal therapy; painting analysis; poisonous gas/air pollution detection; product quality check; beauty treatment & therapy; and restoration of cultural relics is provided.

FIG. 19 shows a flow chart 1900 illustrating a THz data acquisition and analysis method according to an example embodiment. At step 1902, a THz spectroscopy measurement is performed on a sample. At step 1904, sample data based on the THz spectroscopy measurement is acquired. At step 1906, a comparison between the sample data and reference data is performed for identifying the sample.

The method may comprise enriching the reference data by performing machine learning using the sample data upon identification.

The method may comprise using a database for the reference data. The database may contain the refractive index of a list of materials.

The reference data may be stored in a shared data centre external to the system, such as in a cloud data base.

The method may comprise determining the refractive index of the sample. The method may comprise analysing multi-reflection peak positions for the sample with a known thickness, and calculating the refractive index of the sample, which may include performing machine learning.

The method may comprise measuring the thickness of the sample. The method may comprise analysing multi-reflection peak positions of the sample with a known refractive index, and extracting the thickness of the sample. The method may comprise calculating the optical conductivity of the sample based on measurement of the transmission or reflection of the sample.

The method may comprise performing the THz spectroscopy measurement by near-field imaging of the sample.

The THz spectroscopy measurement may comprise using an array of emitters and/or an arrays of detectors. A number of emitters and a number of detectors may be the same or different. The array of emitters may be mounted on a substrate. The array of detectors may be mounted on another substrate or on the same substrate. The substrate or substrates may be flexible. The method may comprise configuring at least one of the substrates for supporting and/or conforming to the sample.

The method may be performed using a portable unit.

The THz spectroscopy measurement may comprise receiving a laser beam for excitation of the THz signal via a free space interface and/or a waveguide interface, such as an optical fibre interface.

The method may be incorporated into an existing surveillance or healthcare method, such as an X-ray scanning method or a metal detector.

The method may comprise using a robotic arm for positioning relative to the sample.

Nowadays, public safety is an increasingly challenging issue in the world. X-ray scanning, ion mass spectroscopy (IMS), microwave scanning, metal detectors, etc. are widely used for safety surveillance. However, the detection of hazardous materials still highly depends on dogs, which are very expensive to train and maintain, involving many uncertainties. Here, a range of THz spectrometers according to example embodiments with unique properties can be provided; (a) the THz emitters and detectors can be arranged in arrays, and compatible with near field detection and flexible configurations, (b) the emitted THz waves can be modulated for complex measurement, including phase array antennas, and (c) the advanced data analysis can greatly enhance the functionality of the THz spectrometers. In terms of the applications, safety surveillance in airports, metro stations, bus stations, shopping malls, etc. have been described above, but embodiments of the present invention can, for example, be expanded to paint analysis, poisonous gas/air pollution detection, product quality check, beauty treatment & therapy, and restoration of cultural relics.

The THz spectrometers according to example embodiments can also be applied in production lines for the thickness measurement and analysis of painting, coating, extruded pipes/tubes, and so on. For example, the array/flexible configuration according to example embodiments can enhance the productivity and detection accuracy.

The THz spectrometers according to example embodiments can be also applied for the analysis of tumor slide, biopsy, cornea, skin and so on.

The detection sensitivity is one of the main concerns of all type of spectrometers. A wide range of THz emitters have been identified with their own specialties according to different embodiments. As a result, the full spectrum range can preferably be covered with a high signal to noise ratio. For low frequency range (0.1-2 THz), ZnTe, GaAs, InAs, InSb crystals, magnetic film stacks and photoconductive antennas are preferably used in example embodiments. For medium frequency range (1-5 THz), LiNbO₃ waveguide and magnetic film stacks are preferably used in example embodiments. For high frequencies (4 THz and above), air-plasmas, organic crystals and magnetic film stacks are preferably used in example embodiments.

In practical materials identification, the measured parameters can be quite fuzzy and/or blur.

Data in-line-processing and machine learning to enhance the accuracy can be employed in example embodiments. In one embodiment, data in-line-processing is performed in an embedded system. As soon as the time domain data are acquired, the system will get the frequency domain information in a short while (down to microseconds). At the same time, this spectrum will be compared with the database for material identification purpose.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A THz data acquisition and analysis system comprising:
a THz spectrometer configured for performing a THz spectroscopy measurement on a sample;
a data acquisition unit configured for acquiring sample data based on the THz spectroscopy measurement; and
a processing unit configured for performing a comparison between the sample data and reference data for identifying the sample.

2. The system of claim 1, wherein the processing unit is be configured for enriching the reference data by performing machine learning using the sample data upon identification.

3. The system of claim 1 or 2, comprising a database for the reference data.

4. The system of claim 3, wherein the database also contains a refractive index of a list of materials.

5. The system of any one of the preceding claims, wherein the reference data are stored in a shared data centre external to the system, such as in a cloud data base.

6. The system of any one of the preceding claims, wherein the processing unit comprises a computing device with an operation system and/or a standalone device, such as field-programmable gate array (FPGA) modules.

7. The system of any one of the preceding claims, the processing unit is further configured to determine the refractive index of the sample.

8. The system of claim 7, wherein the processor is configured to analyse multi-reflection peak positions for the sample with known thickness, and to calculate the refractive index of the sample, which may include performing machine learning.

9. The system of any one of the preceding claims, wherein the processing unit is configured to measure the thickness of the sample.

10. The system of claim 9, wherein the processing unit is configured to analyse multi-reflection peak positions of the sample with known refractive index, and to extract the thickness of the sample.

11. The system of claim 9 or 10, wherein the processing unit is configured to calculate the optical conductivity of the sample based on measurement of the transmission or reflection of the sample.

12. The system of any one of the preceding claims, wherein the THz spectrometer is configured for near-field imaging of the sample.

13. The system of any one of the preceding claims, wherein the THz spectrometer comprises an array of emitters and/or an array of detectors.

14. The system of claim 13, wherein a number of emitters and a number of detectors are the same or different.

15. The system of claim 13 or 14, wherein the array of emitters is mounted on a substrate.

16. The system of claim 15, wherein the array of detectors is mounted on another substrate or on the same substrate.

17. The system of claim 16, wherein the substrate or substrates are flexible.

18. The system of any one of claims 15 to 16, wherein at least one of the substrates is configured for supporting and/or conforming to the sample.

19. The system of any one of the preceding claims, configured as a portable unit.

20. The system of any one of the preceding claims, wherein the THz spectrometer is configured to receive a laser beam for excitation of the THz signal via a free space interface and/or a waveguide interface, such as an optical fibre interface.

21. The system of any one of the preceding claims, wherein the system is incorporated into an existing surveillance or healthcare apparatus, such as an X-ray scanning apparatus or a metal detector.

22. The system of any one of the preceding claims, wherein the system comprises a robotic arm for positioning at least the THz spectrometer relative to the sample.

23. The use of the system of any one of the preceding claims in one or more of a group consisting of safety surveillance; disease diagnosis, including the analysis of biopsy, metabolite, and slide analysis; in skin diagnosis, wherein flexible THz emitters and/or detectors can be bent to fit the human body curvature for accurate analysis; in eye inspection, wherein flexible THz emitters and/or detectors can be bent to fit the cornea curvature for more accurate analysis; in dental care, wherein THz phase array antenna can be applied for a high speed dental check, for instance, for the tooth decay depth before root canal therapy; painting analysis; poisonous gas/air pollution detection; product quality check; beauty treatment & therapy; and restoration of cultural relics.

24. A THz data acquisition and analysis method comprising:
performing a THz spectroscopy measurement on a sample;
acquiring sample data based on the THz spectroscopy measurement; and
performing a comparison between the sample data and reference data for identifying the sample.

25. The method of claim 24, comprising enriching the reference data using the sample data upon identification.

26. The method of claim 24 or 25, comprising using a database for the reference data.

27. The method of claim 26, wherein the database contains the refractive index of a list of materials.

28. The method of any one of claims 24 to 27, wherein the reference data are stored in a shared data centre external to the system, such as in a cloud data base.

29. The method of any one of claims 24 to 28, comprising determining the refractive index of the sample.

30. The method of claim 29, comprising analysing multi-reflection peak positions for the sample with a known thickness, and calculating the refractive index of the sample, which may include performing machine learning.

31. The method of any one of claims 24 to 30, comprising measuring the thickness of the sample.

32. The method of claim 31, comprising analysing multi-reflection peak positions of the sample with a known refractive index, and extracting the thickness of the sample.

33. The method of claim 31 or 32, comprising calculating the optical conductivity of the sample based on measurement of the transmission or reflection of the sample.

34. The method of any one of claims 24 to 33, comprising performing the THz spectroscopy measurement by near-field imaging of the sample.

35. The method of any one of claims 24 to 34, wherein the THz spectroscopy measurement comprises using an array of emitters and/or an arrays of detectors.

36. The method of claim 35, wherein a number of emitters and a number of detectors are the same or different.

37. The method of claim 35 or 36, wherein the array of emitters is mounted on a substrate.

38. The method of claim 37, wherein the array of detectors is mounted on another substrate or on the same substrate.

39. The method of claim 38, wherein the substrate or substrates are flexible.

40. The method of any one of claims 37 to 39, comprising configuring at least one of the substrates for supporting and/or conforming to the sample.

41. The method of any one of claims 24 to 40, performed using a portable unit.

42. The method of any one of claims 24 to 41, wherein the THz spectroscopy measurement comprises receiving a laser beam for excitation of the THz signal via a free space interface and/or a waveguide interface, such as an optical fibre interface.

43. The method of any one of claims 24 to 42, wherein the method is incorporated into an existing surveillance or healthcare method, such as an X-ray scanning method or a metal detector.

44. The method of any one of claims 24 to 43, comprising using a robotic arm for positioning relative to the sample.
